(19) United States
(12) Patent Application Publication
(10) Pub. No.: US 2002/0031640 A1
(43) Pub. Date: Mar. 14, 2002

(54) Multi-purpose covering

(76) Inventor: Carol M. Cihocki, Evergreen Park, IL (US)

Correspondence Address: Matthew J. Peirce, Esq., 1550 Starlight Canyon Avenue, Las Vegas, NV, 89123, US

(21) Appl. No.: 09/949,175

(22) Filed: Sep. 7, 2001

Related U.S. Application Data
(60) Provisional application No. 60/231,203, filed on Sep. 8, 2000.

(51) Int. Cl. B32B 3/06

(52) U.S. Cl. 428/102

(57) ABSTRACT

A new and improved covering apparatus is disclosed which would allow a user to absorb moisture, dirt, and other substances readily. The covering apparatus would comprise two layers, a first layer and a second layer, with the first layer being fabricated from an absorbent material, such as terry cloth and a second layer being fabricated from a waterproof material, such as vinyl plastic backing. The two layers would be bonded or sewn together.

### BACKGROUND OF THE INVENTION

The present invention is that of a new and improved covering apparatus which would allow a user to absorb moisture, dirt, and other substances readily, while not allowing the substrate to penetrate through to the surface being protected.

### DESCRIPTION OF THE PRIOR ART

U.S. Pat. No. 5,843,556, issued to Levas, discloses a combination beach towel, tote bag, deck chair cover and automobile seat cover which will easily convert from a beach towel to one of its other forms.

U.S. Pat. No. 5,785,381, issued to Carter, discloses a seat protector for a driver's seat in a motor vehicle comprising a flexible sheet to fit against a lower portion of a backrest of the driver's seat in the motor vehicle.

U.S. Pat. No. 4,723,814, issued to Hunt, discloses a vehicle seat protection device, for protecting a seat having a back, which consists of a loose seat cover attached to an elongate member.

### SUMMARY OF THE INVENTION

The present invention is that of a new and improved covering apparatus which would allow a user to absorb moisture, dirt, and other substances readily. The covering apparatus would comprise two layers, a first layer and a second layer, with the first layer being fabricated from an absorbent material, such as terry cloth and a second layer being fabricated from a waterproof material, such as vinyl plastic backing. The two layers would be bonded or sewn together.

There has thus been outlined, rather broadly, the more important features of a covering apparatus in order that the detailed description thereof that follows may be better understood and in order that the present contribution to the art may be better appreciated. There are, of course, additional features of the covering apparatus that will be described hereinafter and which will form the subject matter of the claims appended hereto.

In this respect, before explaining at least one embodiment of the covering apparatus in detail, it is to be understood that the covering apparatus is not limited in its application to the details of construction and to the arrangements of the components set forth in the following description or illustrated in the drawings. The covering apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present covering apparatus. It is important, therefore, that the claims be regard as including such equivalent constructions insofar as they do not depart from the spirit and scope of the present invention.

It is therefore an object of the present invention to provide a covering apparatus which has all of the advantages of the prior art and none of the disadvantages.

It is another object of the present invention to provide a covering apparatus which may be easily and efficiently manufactured and marketed.

It is another object of the present invention to provide a covering apparatus which is of durable and reliable construction.

It is yet another object of the present invention to provide a covering apparatus which is economically affordable and available to the buying public.

It is yet another object of the present invention to provide a covering apparatus which provides additional benefits not present in the prior art.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of the present invention.

FIGS. 2 and 3 show various uses of the present invention.

### DESCRIPTION OF THE PREFERRED EMBODIMENT

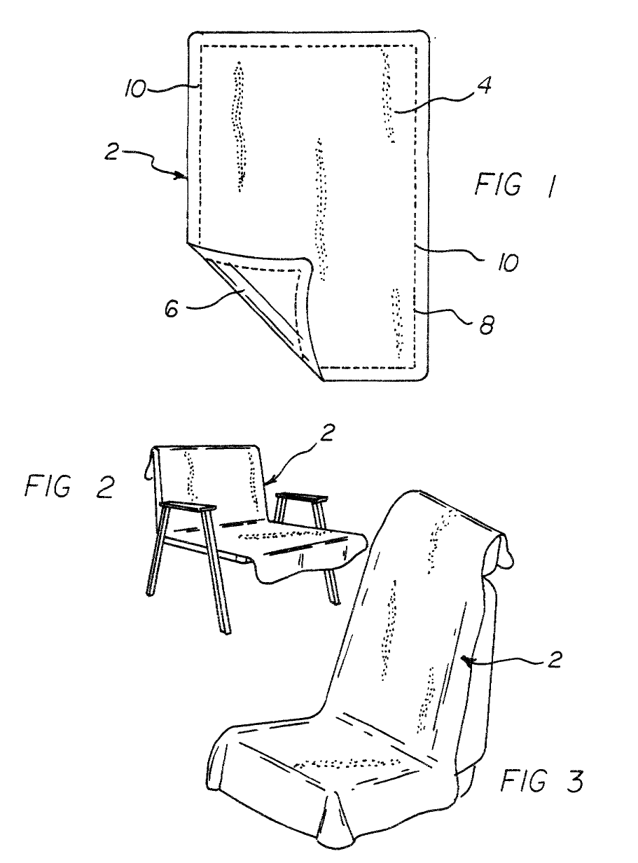

FIG. 1 shows a perspective view of the present invention. The present invention is that of a new and improved covering apparatus 2 which would allow a user to absorb moisture, dirt, and other substances readily. The covering apparatus would comprise two layers, a first layer and a second layer, with the first layer being fabricated from terry cloth 4 and a second layer being fabricated from vinyl plastic backing 6. The two layers would be sewn together with thread 8 and a plurality of stitches 10.

Vinyl plastic backing 6 would be waterproof. Terry cloth 4, on the other hand, would absorb moisture and dirt that it would come into contact with. Vinyl plastic backing 6 prevents moisture and other substances from penetrating through to surfaces in which the covering apparatus 2 has been placed on top of. Covering apparatus 2 would protect from a wide variety of problems, including everyday spills, chlorine-laden swimsuits, algae-laden swimsuit from lake water, wet and soiled pets, and soiled children.

Vinyl plastic backing 6 also blocks wet sand at a beach from clinging to terry cloth 4. The present invention, in addition to serving as a cover, could also be used as a ground covering while picnicking or otherwise resting on an outdoor ground surface. The present invention is ideal for boaters, people with swimming pools, children, and pet owners, and can be used on any occasion where a user might destroy furniture or car seats with wet or soiled clothing.

FIGS. 2 and 3 show various uses of the present invention. In FIG. 2, covering apparatus 2 is being used to cover an outdoor deck chair. In FIG. 3, covering apparatus 2 is being used to cover a car seat. The present invention would not be limited to these two uses, of course, and could be used in a wide variety of other applications.

What I claim as my invention is:

1. A multi-purpose covering apparatus comprising:
(a) a first layer, the first layer being waterproof, the first layer having a length and a width,
(b) a second layer, the second layer being manufactured from a fabric designed to absorb moisture and dirt, the second layer having the same length and width as the first layer, and
(c) a means for fixedly attaching the first layer to the second layer.

2. A multi-purpose covering apparatus according to claim 1 wherein the first layer of the multi-purpose covering apparatus would comprise a vinyl plastic backing.

3. A multi-purpose covering apparatus according to claim 1 wherein the second layer of the multi-purpose covering apparatus would comprise terry cloth.

4. A multi-purpose covering apparatus according to claim 1 wherein the means for fixedly attaching the first layer to the second layer would comprise
(a) a length of thread,
(b) a plurality of holes within the first layer of the multi-purpose covering and the second layer of the multi-purpose covering,
(c) wherein a user would sew the length of thread alternatively through the holes on the first layer of the multi-purpose covering and the second layer of the multi-purpose covering.
